(19) United States
(12) Patent Application Publication
(10) Pub. No.: US 2011/0100961 A1
(43) Pub. Date: May 5, 2011

(54) WELDING PROCESS FOR PRODUCING ROTATING TURBOMACHINERY

(75) Inventor: Robert E. Kilroy, JR., Richmond, VA (US)

(73) Assignee: ALSTOM Technology Ltd, Baden (CH)

(21) Appl. No.: 12/613,282

(22) Filed: Nov. 5, 2009

(51) Int. Cl. B23K 9/18; B23K 20/227; B23K 31/02; B23K 9/173; B23K 9/167

(52) U.S. Cl. 219/73; 228/262.3; 228/101; 219/74; 219/75

(57) ABSTRACT

A method for welding dissimilar metals involved selecting a steel having approximately 1-3 weight % chromium (Cr) content and a first coefficient of thermal expansion at a predetermined first temperature for a first part [14], selecting a nickel-based alloy having a second coefficient of thermal expansion at a second predetermined temperature for a second part [12], the first and second coefficients of thermal expansion having a maximum difference of approximately 2-3% when the first predetermined temperature is approximately 500-550° C. and the second predetermined temperature is approximately 600-650° C., then welding the first part to the second part [12].

### TECHNICAL FIELD

The processes described herein relate in general to welding and, more particularly, to welding processes for producing rotating turbomachinery.

### BACKGROUND

Structural components for high temperature turbomachinery such as that used in gas turbine and steam turbine applications may be forged, cast, or otherwise manufactured and assembled. Various types of these structural components include discs, drums, blades, vanes, casings, housings, shafts, rings, shells, and the like that may be bolted or welded together.

The efficiency of turbo-machinery is largely dependent upon the working temperature of the driving fluids used therein. Higher working temperatures generally translate into increases in turbine efficiency. For example, the rotors of steam turbines used in power plants are typically subjected to steam temperatures of greater than 650° C. Because steam at a high temperature is capable of giving up more energy than steam at a lower temperature, such turbines are generally highly efficient as compared to turbines that operate at lower temperatures.

Because the various turbomachinery components in a turbine are subjected to a wide variety of extreme conditions with regard to temperature, pressure, mechanical stresses, and the like, and because many of such components are exposed to corrosive conditions, different materials are used in the construction of the components. For example, in high-temperature turbine applications in which the blades or vanes of a rotor are impinged on by the flow of high pressure steam, the surfaces of the blades or vanes are directly subjected to the steam and may experience effects such as pitting or spalling over time. When the high-pressure, high temperature steam is directed at the surfaces of the blades or vanes, the structure that supports the blades or vanes (such as the discs or drums) may not fully or directly receive the steam. Because the discs or drums may not directly receive the steam and because the discs or drums may not experience effects such as pitting or spalling, the discs or drums may be manufactured from materials that are less capable of resisting the effects of steam but are lighter and/or less expensive, thereby allowing the turbine to have the desired structural integrity at a reasonable cost while maintaining a suitable weight.

In using different materials in the construction of a turbine and the components thereof, materials with high creep strength are generally used in surfaces exposed to higher temperatures, and materials with higher toughness are used in surfaces exposed to lower temperatures. In general, nickel-based alloys (e.g., superalloys) are typically used at higher temperatures and in conjunction with standard steels at lower temperatures. Such standard steels are generally chromium steels having about 9-12 weight % (wt. %) chromium. Because of the use of disparate materials, the effects of differences in thermal expansion are often experienced. For example, with regard to steels, the coefficients of thermal expansion are more than about 10% lower than the coefficient of thermal expansion of the nickel-based alloy used. The use of materials with different coefficients of thermal expansion often leads to high thermal stresses during temperature changes because different materials will expand or contract at different rates. These thermally-induced stresses may reduce component life.

When the rates of temperature change experienced by materials having different coefficients of thermal expansion are significant, the thermally induced stresses can cause the metal surfaces to creep. Creep is a time-dependent strain that results in plastic deformation of the metal. Creep is sensitive to temperature, and the sensitivity increases as temperature increases. After a period of time, creep can result in the formation of cracks or fractures in the metal.

Currently, there is a need to weld parts having creep-resistant materials in high temperature environment, to a less expensive material in a lower temperature sections.

### SUMMARY

The present invention may be embodied as a method of welding dissimilar metals, the method having the steps of:

providing a first part [14] operating in a first predetermined temperature made from steel with approximately 1-3 weight % chromium having a first coefficient of thermal expansion;

providing a second part [12] operating in a second predetermined temperature made from a nickel-based alloy and having a second coefficient of thermal expansion;

welding the first part [14] and the second part [12] together; and wherein the first and second coefficients of thermal expansion differ by a predetermined maximum deviation of up to 3% when the first part [14] is at the first predetermined operating temperature and the second part [12] is at the second predetermined operating temperature.

The present invention may also be embodied as a method of manufacturing a rotor for turbomachinery, the method comprising:

providing first and second end pieces [14] formed from steel, each end piece [14] has a creep strength at a first predetermined operating temperature that is approximately equal to a creep strength of steel having a chromium content of about 9-12 weight % at a second predetermined operating temperature;

providing at least one disc [12] formed at least in part from a nickel-based alloy having a creep strength that is approximately equal to the creep strength of the steel of the first and second end pieces [14]; and

welding the end pieces [14] to the disc [12].

Also, the present invention may be embodied as a method of creating an economical creep-resistant device from a first part [14] intended to operate at a first predetermined operating temperature and a second apart [12] intended to operate at a second predetermined operating temperature. The method includes:

selecting a first part [14] constructed from a first creep-resistant material having a first coefficient of thermal expansion at the first predetermined operating temperature,

selecting a second part [12] constructed from a creep-resistant material having a second coefficient of thermal expansion at the second predetermined operating temperature that is within a predefined differential percentage of the first coefficient of thermal expansion; and

welding the first part [14] to the second part [12].

The above described and other features are exemplified by the following Figures and Detailed Description.

### BRIEF DESCRIPTION OF THE FIGURES

Referring now to the Figures, which are exemplary embodiments, and wherein the like elements are numbered alike:

FIG. 1 is an exploded sectional schematic depiction of a rotor; and

FIG. 2 is a schematic depiction of a detail of the rotor of FIG. 1.

### DETAILED DESCRIPTION

In one aspect, turbomachinery is produced, at least in part, using a combination of components, some of which are made from nickel alloys and some of which are made from steel. These components are often joined to one another by welding. During operation, turbomachines are typically subjected to very high temperatures. However, portions of the turbomachines remain at lower temperatures. Depending on the materials selected and the extent of the differences in coefficients of thermal expansion between them, high, thermally induced stresses can be introduced into the components.

Accordingly, and to minimize the thermally induced stresses, the materials used in the turbomachine, particularly where dissimilar materials are welded together need to be properly matched. Therefore, in one aspect of this disclosure, materials with similar expansion coefficients are employed.

As temperatures increase, creep resistance strength is reduced.

For high temperature applications, expensive nickel-based alloys are used in the hottest areas where temperatures exceed 650° C. since they are highly creep resistant. The nickel-based alloys are then joined to less costly, creep-resistant steels. The creep-resistant steels are not as creep resistant as the nickel alloys, but are useful in lower temperature areas and hereinafter referred to as low chromium (Cr) steel that contain a Cr content of between about 1% by weight (wt. %) to about 3 wt. %. The expansion coefficient of the steel having the low Cr content is within approximately 2% to about 3% of that for the nickel alloy. Because the steel is at a temperature that is about 50° C. to about 100° C. less than the nickel alloy, it is possible to select a steel having about 1 wt. % to about 3 wt. % Cr and having a creep strength similar to that of a 9-12 wt. % steel at about 600° C. to about 650° C. and very similar thermal expansion properties. Therefore, the low Cr content steel at the lower operating temperature (approximately 550° C.), exhibits very similar expansion rates and creep strength as the nickel alloy at the higher operating temperature (approximately 600-650° C.).

Where the nickel-based alloy and the low Cr steel are welded together with the low Cr steel, because of the similarity in expansion coefficients, there is no need for an additional joint, or an overlay weld of steel having, for example, a 9-12 wt. % Cr between the nickel alloy and the low Cr steel to accommodate the traditionally significant differences in thermal expansion coefficient.

Turbomachinery typically comprises high-speed rotating components such as rotors, discs, drums, and the like. In addition to the high-speed rotating components, stationary components such as housings, frames, and the like also form portions of most turbomachines. Turbomachines are often driven by high pressure, high temperature fluids, such as, for example, steam. These driving fluids can be introduced into the turbine at temperatures exceeding 500° C. Accordingly, there can be large temperature differentials in a turbine whereby during operation, some components are extremely hot while others are cool.

As used herein, the term “creep strength” refers to quantifiable forces, which, at a given temperature, will result in a creep rate of 1% deformation within 100,000 hours. The temperature at which the stress is measured is typically the highest operating temperature of the turbomachinery. Materials in which the creep rate is less than 1% deformation within 100,000 hours at the highest operating temperature of the turbomachinery are herein defined as being “creep-resistant.”

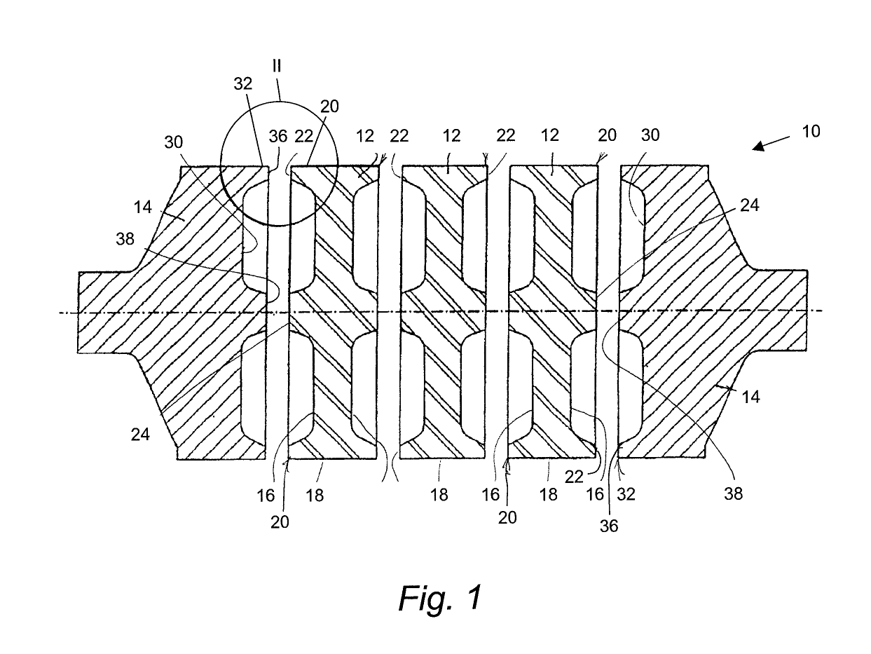

Referring to FIG. 1, a rotor of a turbine is shown generally at 10 and is hereinafter referred to as “rotor 10.” By way of example, the rotor, as it forms part of a turbomachine, is typically subjected to temperature extremes with the outer portions of the rotor operating at a lower temperature than the inner portions of the rotor. Accordingly, where the rotor comprises different materials, the potential for detrimentally high thermally induced stresses exist. Note that the rotor described herein is included for illustrative purposes and is in no way to be considered limiting as the disclosure herein can find utility in numerous different turbomachines, turbomachine components, and where dissimilar metals are welded together and subjected to temperature differentials. Rotor 10 includes a plurality of discs 12 and end pieces 14. Each disc 12 has opposing faces 16 and an edge surface 18. The discs 12 are arranged face-to-face and define a “sandwich” structure in which the end pieces are located at opposing ends of the arranged discs. The discs 12 of the rotor 10 may support elements such as blades or vanes depending on the machine in which the rotor is used. The end pieces 14 can facilitate mounting the rotor 10 in a supporting structure that allows for rotation of the rotor.

The face 16 of each disc 12 includes a rim 20 that protrudes from the face. When the rotor 10 is assembled, the disc 12 interfacially engages adjacent discs 12 or an adjacent end piece 14 at an outer surface 22 of the rim 20 such that the outer surfaces engage one another. In the illustrated embodiment, the face 16 of each disc 12 also includes a hub 24 that protrudes from the face.

The discs 12 define the high temperature portion of the rotor 10. At least the outer edge surfaces 18 of the discs 12 are subjected to the high temperatures typically encountered in such machines as steam turbines. At least the edge surfaces 18 of the discs 12 are made from nickel-based alloys. However, the entire disc can also be formed from the nickel-based alloy. The nickel-based alloy may also be deposited as a coating on the discs 12, or the nickel-based alloy may be welded to the discs.

In the illustrated embodiment, a face 30 of each end piece 14 that is positioned adjacent a disc 12 also includes a protruding rim 32. An outer surface 36 of the rim 32 interfacially engages the outer surface 22 of the rim 20 of the adjacently positioned disc 12. The face 30 of each end piece 14 also includes a hub 38 that protrudes from the face to engage the hub 24 of an adjacently positioned disc 12.

The end pieces 14 define the low temperature portion of the rotor 10. The end pieces 14 are subjected to the lower temperatures (less than about 650° C.) and are defined by low Cr steels. The chromium contents of such steels are typically about 1 wt. % to about 3 wt. %. Other elements may be included with the steels to impart desirable properties to the steels. One such desirable property of these steels is that the coefficients of thermal expansion are within about 2-3% of the coefficient of thermal expansion of the nickel-based alloy used in the discs 12.

Because the coefficient of thermal expansion of the steel is similar to the coefficient of thermal expansion of the nickel-based alloy used, the steels used in the end pieces 14, like the nickel-based alloys used in the discs 12, are deemed to have suitable creep strengths in particular temperature ranges. The creep strength of the steel used in the rotor 10 described herein approximates the creep strength of chromium steel in which the chromium content is 9-12 wt. %. However, in comparing the creep strengths of the two different steels, the creep strength of the chromium steel having 9-12 wt. % chromium is measured at a temperature that is 50-100 centigrade degrees higher than the creep strength of the steel used in the rotor 10 of the present invention. In particular, the chromium steel used in the rotor 10 has a creep strength at about 550° C. that is similar and approximately equal, in spite of the chromium being 1-3 wt. %, to the creep strength of chromium steel in which the chromium content is 9-12 wt. % at 600-650° C. The creep strength of the steel used in the end pieces 14 is also approximately equal (e.g., within about 10%) to the creep strength of the nickel-based alloy of the discs 12.

The discs 12, all of which may consist of the same nickel-based alloy or at least similar alloys, can be connected to one another by welding. In doing so, the discs 12 are arranged such that the outer surface 22 of the rim 20 of one disc engages the outer surface of the rim of at least one other disc. Techniques for welding the discs 12 together at the engaging outer surfaces 22 of the rims 20 include, but are not limited to, techniques that utilize metal active gas (MAG), tungsten inert gas (TIG), or methods that utilize a submerged arc with strip electrodes.

The nickel-based alloy of the discs 12 may be a niobium-containing nickel-based alloy (e.g., Alloy 625, which includes nickel, chromium, niobium, and other elements). The embodiments disclosed herein are not so limited, as the discs 12 can be formed from other alloys.

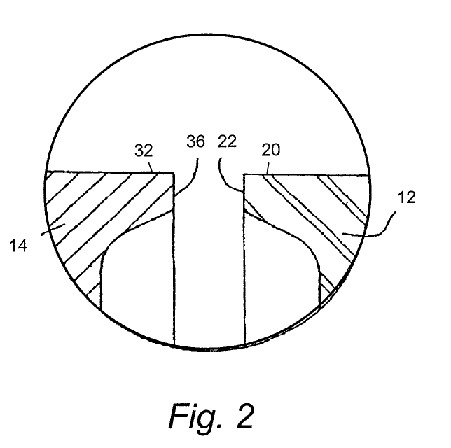

Referring now to FIG. 2, the end pieces 14 are welded to the end discs 12 on the assembly of discs to define the assembled rotor 10. The outer surface 36 of the rim 32 of the end piece 14 is attached to the outer surface 22 of the rim 20 of the adjacently positioned disc 12. Welding techniques that melt as little as possible of the nickel-based alloy of the disc 12 are used. Such techniques include, but are not limited to, welding techniques that utilize metal active gas (MAG), tungsten inert gas (TIG), or methods that utilize a submerged arc with strip electrodes as described above with reference to the welding of the discs 12 to each other. As such, the nickel-based alloy and the steel are joined, thereby making a transition directly from the nickel-based alloy of the discs 12 to the steel of the end pieces 14 without employing a joint or overlay weld.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A method of welding dissimilar metals, the method comprising:
providing a first part intended to operate in a first predetermined temperature made from steel with approximately 1-3 weight % chromium having a first coefficient of thermal expansion;
providing a second part intended to operate in a second predetermined temperature made from a nickel-based alloy and having a second coefficient of thermal expansion;
wherein the first and second coefficients of thermal expansion differ by a predetermined maximum deviation of up to 3% when the first part is at the first predetermined operating temperature and the second part is at the second predetermined operating temperature; and
welding the first part and the second part together.

2. The method of claim 1, wherein the predetermined maximum deviation is approximately 1-3%

3. The method of claim 1, wherein the predetermined maximum deviation is approximately 2-3%

4. The method of claim 1, wherein the first predetermined operating temperature is between 500 and 650° C.

5. The method of claim 1, wherein the first predetermined operating temperature is about 550° C. and the second predetermined operating temperature is about 650° C.

6. The method of claim 1, wherein welding the first part and the second part together comprises welding using a metal active gas welding technique.

7. The method of claim 1, wherein welding the first part and the second part together comprises welding using a tungsten inert gas welding technique.

8. The method of claim 1, wherein welding the first part and the second part together comprises welding using a submerged arc welding technique using strip electrodes.

9. The method of claim 1, wherein the steel of the first part has a creep strength that is approximately equal to a creep strength of steel having a chromium content of about 9-12 wt. % at about 600-650° C.

10. A method of manufacturing a rotor for turbomachinery, the method comprising:
providing first and second end pieces formed from steel, each end piece has a creep strength at a first predetermined operating temperature that is approximately equal to a creep strength of steel having a chromium content of about 9-12 weight % at a second predetermined operating temperature;
providing at least one disc formed at least in part from a nickel-based alloy having a creep strength that is approximately equal to the creep strength of the steel of the first and second end pieces; and
welding the end pieces to the disc.

11. The method of claim 10, wherein the end pieces have a chromium content that is about 1-3 weight %.

12. The method of claim 10, wherein the first predetermined operating temperature is about 500-550° C.

13. The method of claim 10, wherein the second predetermined operating temperature is about 600-650° C.

14. The method of claim 10, wherein the step of providing at least one disc comprises providing a plurality of discs arranged face-to-face and interfacially stacked, and
wherein the step of welding the end piece to the disc comprises welding the first end piece to one disc in the plurality of discs and welding the second end piece to another disc in the plurality of discs [12].

15. The method of claim 10, wherein the step of welding the end pieces to the disc comprises welding the end pieces to the disc using a metal active gas welding technique.

16. The method of claim 10, wherein the step of welding the end pieces to the disc comprises welding the end pieces to the disc using a tungsten inert gas welding technique.

17. The method of claim 10, wherein the step of welding the end pieces to the disc comprises welding the end pieces to the disc using a submerged arc welding technique using strip electrodes.

18. A method of creating an economical creep-resistant device from a first part intended to operate at a first predetermined operating temperature and a second apart intended to operate at a second predetermined operating temperature, the method comprising:
selecting a first part constructed from a first creep-resistant material having a first coefficient of thermal expansion at the first predetermined operating temperature,
selecting a second part constructed from a creep-resistant material having a second coefficient of thermal expansion at the second predetermined operating temperature that is within a predefined differential percentage of the first coefficient of thermal expansion; and
welding the first part to the second part.

19. The method of claim 18, wherein the differential percentage is approximately 2-3%.
